(19) United States
(12) Patent Application Publication
(10) Pub. No.: US 2017/0219517 A1
(43) Pub. Date: Aug. 3, 2017

(54) GAS SENSOR UNIT

(71) Applicant: NGK Spark Plug Co., LTD., Nagoya (JP)

(72) Inventors: Daisuke UEMATSU, Konan (JP); Tomohiro WAKAZONO, Konan (JP); Masaki NAKAGAWA, Komaki (JP); Kentaro KAMADA, Komaki (JP); Hiroyuki HAYASHI, Konan (JP)

(73) Assignee: NGK Spark Plug Co., LTD., Nagoya (JP)

(21) Appl. No.: 15/418,064

(22) Filed: Jan. 27, 2017

(30) Foreign Application Priority Data
Jan. 28, 2016 (JP) 2016-014009

(51) Int. Cl. G01N 27/41; G01N 27/406; G01N 27/407

(52) U.S. Cl. CPC G01N 27/41; G01N 27/4075; G01N 27/4067

(57) ABSTRACT

A gas sensor unit includes a gas sensor and a control unit. The gas sensor unit includes: a first oxygen pump cell having a pair of electrodes and controlling the oxygen concentration; a second oxygen pump cell controlling the oxygen concentration; and a sensor cell that detects the concentration of a specific gas component in a measurement target gas. The control unit is electrically connected to the gas sensor and sets a voltage between the pair of electrodes of the first oxygen pump cell to a predetermined set value, and performs energization control to control the introduction or discharge of oxygen while changing a voltage applied between a pair of electrodes of the second oxygen pump cell so that an oxygen pump current of the first oxygen pump cell is maintained within a predetermined range of IL≦I≦IH.

This application claims the benefit of Japanese Patent Application No. 2016-014009, filed Jan. 28, 2016, which is incorporated herein in its entirety by reference.

### FIELD OF THE INVENTION

The present invention relates to a gas sensor unit including a gas sensor and a control unit, for detecting the concentration of a specific gas such as oxygen or NOx contained in a combustion gas or an exhaust gas from a combustor, an internal combustion engine, or the like.

### BACKGROUND OF THE INVENTION

Conventionally, as a gas sensor which is mounted to, for example, an exhaust system such as an exhaust pipe of a combustion engine and detects the concentration of a specific gas in an exhaust gas, a gas sensor has been known which includes at least one cell having a pair of electrodes disposed on both opposite surfaces of a solid electrolyte body.

One example of such an NOx sensor is an NOx sensor (element) 100 shown in FIG. 4 (refer to Japanese Patent Application Laid-Open (kokai) No. 2013-88119 and Japanese Patent No. 3607453). This NOx sensor (element) 100 has, at a distal end portion thereof, a sample gas chamber 70 to which a measurement target gas containing NOx is introduced, and has a first oxygen pump cell 40 and a second oxygen pump cell 20 that are disposed on and under the sample gas chamber 70, respectively, so as to face the sample gas chamber 70. One of two electrodes of each of the first oxygen pump cell 40 and the second oxygen pump cell 20 is disposed so as to face the sample gas chamber 70. Further, a sensor cell 30 faces an upper surface of the sample gas chamber 70 on a rear side relative to the first oxygen pump cell 40. In addition, a heater 60 is stacked beneath the second oxygen pump cell 20. The heater 60 heats solid electrolyte bodies of the first oxygen pump cell 40 and the second oxygen pump cell 20 to an activation temperature.

In this NOx sensor 100, the relationship between a voltage V applied to the oxygen pump cell and an oxygen pump current I that flows in the cell is obtained in advance. Then, the two oxygen pump cells 20 and 40 are electrically connected in parallel, and a voltage according to a predetermined oxygen concentration is applied so that the oxygen pump current I becomes equal to a limiting current I0, thereby controlling the oxygen concentration in the sample gas chamber 70 to a predetermined low concentration. Further, a predetermined voltage is applied to the sensor cell 30 in the sample gas chamber 70 in which the oxygen concentration is controlled as described above, and an NOx concentration is obtained on the basis of an amount of oxygen ions that migrate due to the voltage application, that is, on the basis of the magnitude of an oxygen ion current in the sensor cell 30.

Since the NOx sensor 100 includes the two oxygen pump cells 20 and 40, oxygen dischargeability of the sample gas chamber 70 is enhanced, and the NOx concentration can be accurately measured.

### Problems to be Solved by the Invention

The above-described NOx sensor 100 performs a feedback control to change the voltage V applied to the two oxygen pump cells 20 and 40 so that the oxygen pump current I when a voltage V0 is applied becomes equal to the limiting current I0.

Specifically, as shown in FIG. 5, when the oxygen gas concentration in the sample gas chamber 70 is increased, the limiting current indicating the oxygen pump current I becomes higher than I0. So, the voltage V applied to the two oxygen pump cells 20 and 40 is increased from V0 to further pump out oxygen from the sample gas chamber 70. On the other hand, when the oxygen gas concentration in the sample gas chamber 70 is decreased, the limiting current indicating the oxygen pump current I becomes lower than I0. So, the voltage V applied to the two oxygen pump cells 20 and 40 is decreased from V0 to control pumping-out of oxygen from the sample gas chamber 70.

However, since the distances from the heater 60 to the two oxygen pump cells 20 and 40 are different from each other, the temperatures of the oxygen pump cells 20 and 40 are also different from each other. Therefore, when the two oxygen pump cells 20 and 40 electrically connected in parallel are controlled with the common applied voltage, the above-described feedback control becomes inaccurate, which makes it difficult to accurately control the oxygen gas concentration in the sample gas chamber 70.

That is, as shown by a broken line in FIG. 6, the internal resistance of the solid electrolyte body increases as the cell temperature decreases, and the gradient of rising of the oxygen pump current vs. applied voltage curve becomes small. As a result, the oxygen pump current I does not become equal to the limiting current I0 even when the initial voltage V0 is applied, and the amount of introduced or discharged oxygen becomes insufficient as compared to a predetermined amount.

An objective of the present invention is to provide a gas sensor unit capable of promptly and accurately controlling the oxygen concentration in an internal space by using two oxygen pump cells, and accurately measuring the concentration of a specific gas component.

### SUMMARY OF THE INVENTION

### Means for Solving the Problems

In order to solve the above problems, a gas sensor unit according to the present invention includes a gas sensor and a control unit. The gas sensor includes: an internal space into which a target gas is introduced through a predetermined diffusion resistor; a first oxygen pump cell having a pair of electrodes which are disposed on a first solid electrolyte body having oxygen ion conductivity so that one of the electrodes faces the internal space, the first oxygen pump cell introducing oxygen into or discharging oxygen from the internal space by energization of the pair of electrodes, thereby to control an oxygen concentration in the internal space; a second oxygen pump cell having a pair of electrodes which are disposed on a second solid electrolyte body having oxygen ion conductivity so that one of the electrodes faces the internal space, the second oxygen pump cell introducing oxygen into or discharging oxygen from the internal space by energization of the pair of electrodes, thereby to control the oxygen concentration in the internal space; and a sensor cell having a pair of electrodes which are disposed on a third solid electrolyte body having oxygen ion conductivity so that one of the electrodes faces the internal space, the sensor cell detecting a concentration of a specific gas component in the target gas on the basis of a value of a current that flows in the pair of electrodes. The control unit is electrically connected to the gas sensor. The control unit sets a voltage between the pair of electrodes of the first oxygen pump cell to a predetermined set value, and performs energization control to control introduction or discharge of oxygen while changing a voltage applied between the pair of electrodes of the second oxygen pump cell so that an oxygen pump current between the pair of electrodes of the first oxygen pump cell is maintained within a predetermined range.

This gas sensor unit performs a control to change the voltage applied to the second oxygen pump cell so that the oxygen pump current is maintained within the predetermined range when the voltage of the predetermined set value is applied to the first oxygen pump cell, and detects the concentration of the specific gas component while keeping the oxygen concentration in the internal space constant.

Therefore, if the temperature of the first oxygen pump cell is kept equal to or higher than a predetermined temperature, the oxygen pump current can be reliably made equal to a limiting current when the voltage of the above-described set value is applied, whereby introduction or discharge of a predetermined amount of oxygen can be accurately performed. As a result, the oxygen concentration in the internal space can be promptly and accurately controlled by the first oxygen pump cell and the second oxygen pump cell, and the concentration of the specific gas component can be accurately measured.

In the gas sensor unit according to the present invention, the first and third solid electrolyte bodies may be a common solid electrolyte body. The first oxygen pump cell and the sensor cell of the gas sensor may be provided in the common solid electrolyte body, and the second solid electrolyte body may be another solid electrolyte body.

According to this gas sensor unit, the structure of the gas sensor can be simplified by reducing the number of the solid electrolyte bodies. In addition, since the first oxygen pump cell is provided in the solid electrolyte body shared with the sensor cell, disturbance such as voltage fluctuation is suppressed to be applied to the sensor cell through the solid electrolyte body, resulting in more accurate measurement of the specific gas component concentration.

In the gas sensor unit according to the present invention, the set value may be one constant value.

According to this gas sensor unit, since the set value of the voltage for the first oxygen pump cell is one constant value, reliable and simple control can be realized.

### Effects of the Invention

According to the present invention, the oxygen concentration in the internal space can be promptly and accurately controlled by the first oxygen pump cell and the second oxygen pump cell, and the concentration of the specific gas component can be accurately measured.

### BRIEF DESCRIPTION OF THE DRAWINGS

These and other features and advantages of the present invention will become more readily appreciated when considered in connection with the following detailed description and appended drawings, wherein like designations denote like elements in the various views, and wherein:

FIG. 1 is an overall cross-sectional view of a gas sensor unit according to an embodiment of the present invention.

FIG. 2 is a schematic cross-sectional view showing a distal end portion of a gas sensor element included in a gas sensor, and a control unit for the gas sensor, in the gas sensor unit according to the embodiment of the present invention.

FIG. 3 is an exploded and developed view of the gas sensor element.

FIG. 4 is a schematic cross-sectional view of a distal end portion of a gas sensor element included in a conventional NOx sensor.

FIG. 5 is a diagram showing a relationship between a voltage applied to an oxygen pump cell and an oxygen pump current.

FIG. 6 is another diagram showing a relationship between a voltage applied to an oxygen pump cell and an oxygen pump current.

### DETAILED DESCRIPTION OF THE INVENTION

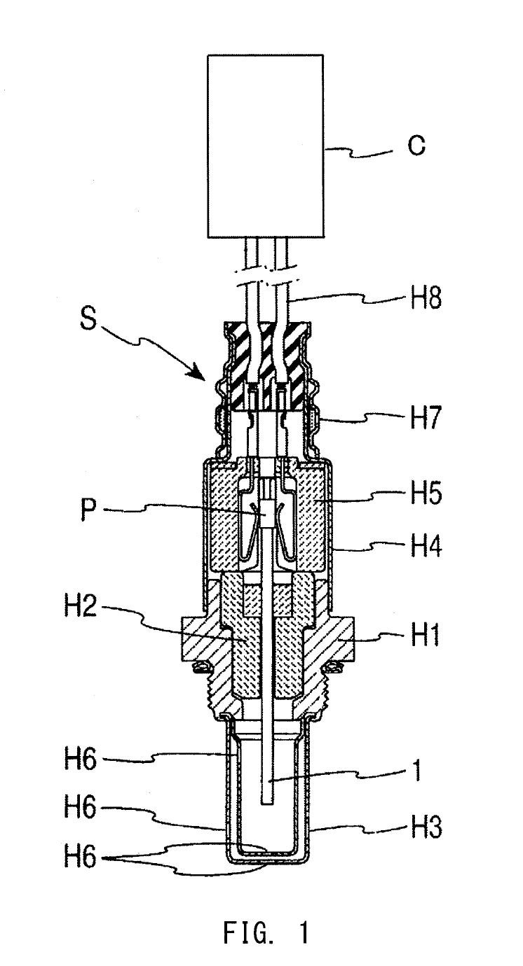

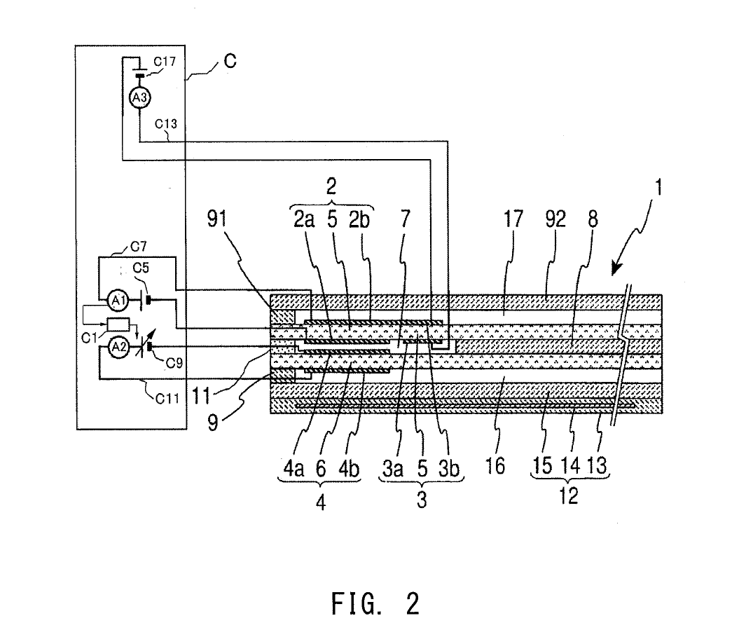

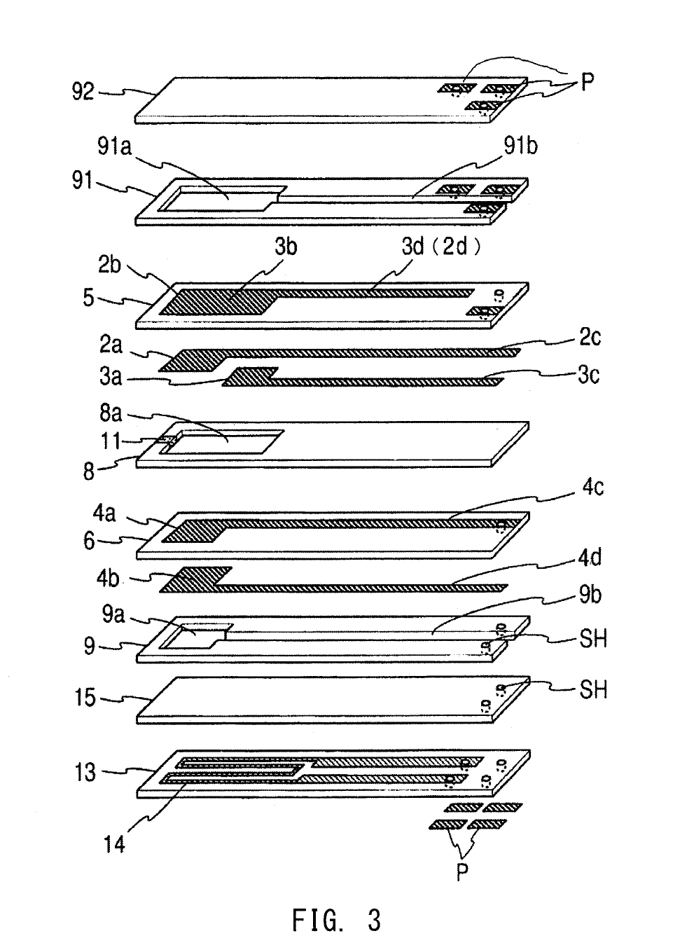

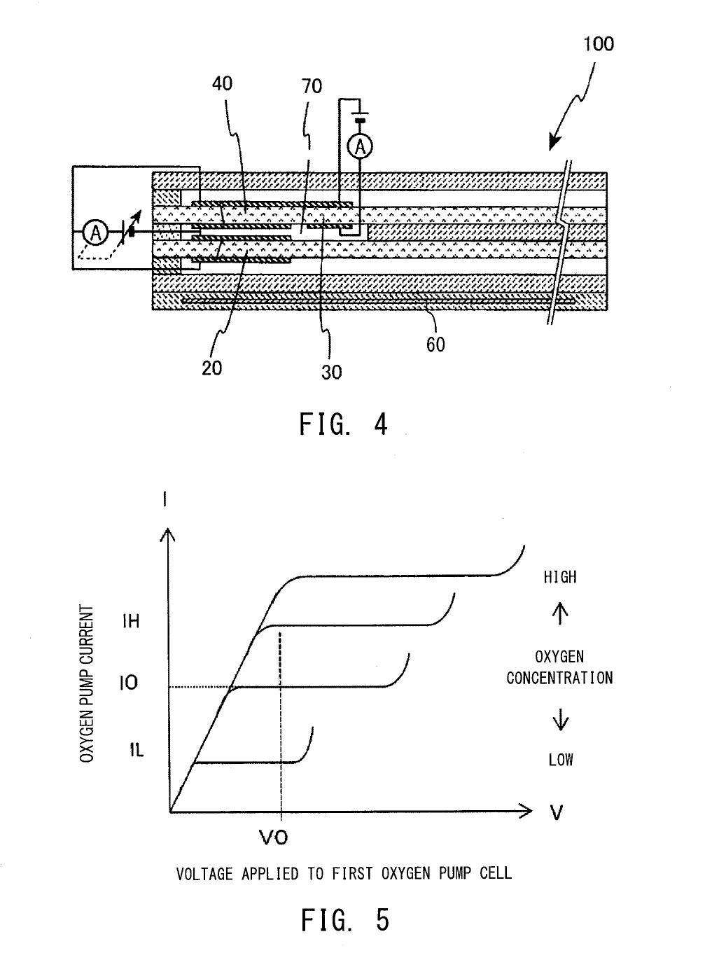

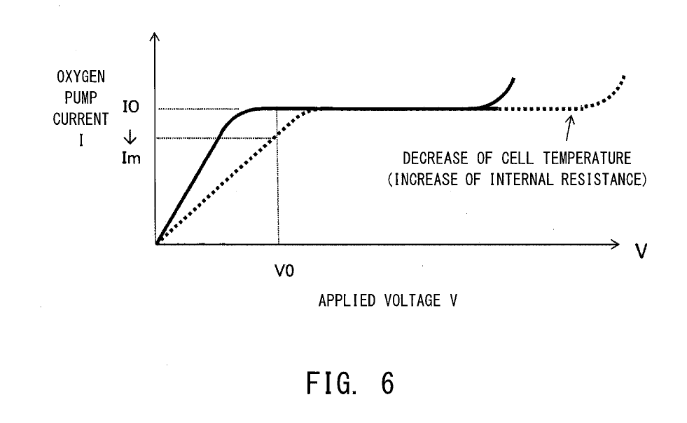

Hereinafter, the present invention will be described in detail with reference to the drawings. FIG. 1 shows the entire structure of a gas sensor unit for an internal combustion engine, according to an embodiment of the present invention. In this embodiment, a gas sensor (NOx sensor) S is provided in, for example, a discharge passage of an automotive engine as an internal combustion engine, and detects a specific gas component, for example, NOx (nitrogen oxide), contained in an exhaust gas as a measurement target gas. FIG. 2 is a schematic cross-sectional view of a distal end portion of a gas sensor element 1 included in the NOx sensor S, and FIG. 3 is an exploded and developed view thereof.

With reference to FIG. 1, the NOx sensor S has a tubular housing H1 mounted to an exhaust pipe wall (not shown), and a gas sensor element 1 held in an insulated manner in the housing H1. The gas sensor element 1 has an elongated plate shape. A center portion of the gas sensor element 1 is held in a tubular insulator H2 disposed in the housing H1, and a distal end portion (a lower end portion in FIG. 1) thereof is housed in an element cover H3 fixed to a lower end of the housing H1. A proximal end portion (an upper end portion in FIG. 1) of the gas sensor element 1 is located in a tubular member H4 fixed to an upper end of the housing H1, and terminals P are connected to lead wires H8 extended to the outside. A space between the tubular member H4 and the proximal end portion of the gas sensor element 1 is filled with a tubular insulator H5.

The element cover H3 projecting into the exhaust pipe has an inner and outer double structure, and exhaust ports H6 are provided in side walls and bottom walls thereof. Thereby, the exhaust gas that flows through the discharge passage can be taken, as the measurement target gas containing the specific gas component, into the element cover H3 in which the distal end portion of the gas sensor element 1 is located. On the other hand, an atmosphere port H7 is formed in a side wall of an upper end portion of the tubular member H4 exposed to the outside of the exhaust pipe, and atmospheric air as a reference oxygen concentration gas is introduced to the inside of the tubular insulator H5 in which the proximal end portion of the gas sensor element 1 is located. Thus, atmospheric air can be introduced to the inside of the gas sensor element 1 from the space inside the tubular insulator H5 in which the common reference oxygen concentration gas exists.

Meanwhile, a controller (control unit) C is electrically connected to the rear end side of the lead wires H8 through connectors or the like. Thus, the NOx sensor S and the controller C constitute a “gas sensor unit.”

With reference to FIGS. 2 and 3, the gas sensor element 1 is formed by stacking, in order, a sheet-like solid electrolyte body 6 for forming the second oxygen pump cell 4; a sheet-like solid electrolyte body 5 for forming the first oxygen pump cell 2 and the sensor cell 3; a sheet-like spacer 8 for forming the internal space 7; sheet-like spacers 9 and 91 for forming a first reference gas space 17 and a second reference gas space 16; and a heater 12 for heating these components.

The internal space 7 is a chamber into which the measurement target gas is introduced from a space where the measurement target gas exists. As shown in FIG. 3, the internal space 7 is formed of a cut hole 8a formed in the spacer 8 located between the solid electrolyte bodies 5 and 6. In this embodiment, the measurement target gas existing space is an inner space of the element cover H3 shown in FIG. 1, into which the exhaust gas flowing through the discharge passage of the internal combustion engine is introduced as the measurement target gas.

The internal space 7 is in communication with the measurement target gas existing space through a porous diffusion resistor 11. The shape, porosity, and pore size of the porous diffusion resistor 11 are appropriately designed so that the diffusion rate of the measurement target gas that is introduced into the internal space 7 through the porous diffusion resistor 11 is equal to a predetermined rate.

Atmospheric air as the common reference oxygen concentration gas having a constant oxygen concentration is introduced into the first reference gas space 17 and the second reference gas space 16. The first reference gas space 17 and the second reference gas space 16 are formed of a cut hole 91a formed in the spacer 91 stacked above the solid electrolyte body 5 and a cut hole 9a formed in the spacer 9 stacked beneath the solid electrolyte body 6, respectively. The cut holes 9a and 91a have passage portions 9b and 91b, respectively, as grooves extending in the longitudinal direction of the gas sensor element 1. The passage portions 9b and 91b are opened at the proximal end side (right end side in FIG. 3) of the spacers 9 and 91, respectively, and are in communication with the space inside the tubular insulator H5, which is a space where the common reference oxygen concentration gas exists.

The heater 12 is stacked under the spacer 9, and a sheet 92 made of an insulating material is stacked on the spacer 91, whereby the upper and lower openings of the cut holes 9a and 91a and the passage portions 9b and 91b are closed. Thus, the atmospheric air is introduced into the first and second reference gas spaces 17 and 16 through the passage portions 91b and 9b. The respective spacers 8, 9, and 91 are made of an insulating material such as alumina.

The solid electrolyte bodies 5 and 6 for forming the first oxygen pump cell 2, the second oxygen pump cell 4, and the sensor cell 3 are made of electrolyte having oxygen ion conductivity such as zirconia and ceria. The first oxygen pump cell 2 includes the solid electrolyte body 5 and a pair of electrodes 2a and 2b disposed so as to oppose each other with the solid electrolyte body 5 therebetween. The electrode 2a which is one of the pair of electrodes 2a and 2b is disposed in contact with a lower surface of the solid electrolyte body 5 so as to face the internal space 7, while the other electrode 2b is disposed in contact with an upper surface of the solid electrolyte body 5 so as to face the first reference gas space 17.

The second oxygen pump cell 4 includes the solid electrolyte body 6, and a pair of electrodes 4a and 4b disposed so as to oppose each other with the solid electrolyte body 6 therebetween. The electrode 4a which is one of the pair of electrodes 4a and 4b is disposed in contact with an upper surface of the solid electrolyte body 6 so as to face the internal space 7, while the other electrode 4b is disposed in contact with a lower surface of the solid electrolyte body 6 so as to face the second reference gas space 16. The electrode 4a of the second oxygen pump cell 4 and the electrode 2a of the first oxygen pump cell 2 face the internal space 7 and oppose each other. In this embodiment, the electrodes 4a and 2a are disposed at opposed positions in the vertical direction in FIG. 3.

The sensor cell 3 includes the solid electrolyte body 5, and a pair of electrodes 3a and 3b disposed so as to oppose each other with the solid electrolyte body 5 therebetween. The electrode 3a which is one of the pair of electrodes 3a and 3b is disposed in contact with the lower surface of the solid electrolyte body 5 so as to face the internal space 7, while the other electrode 3b is disposed in contact with the upper surface of the solid electrolyte body 5 so as to face the first reference gas space 17. The electrodes 3a and 3b of the sensor cell 3 are, in the internal space 7, disposed downstream of the first oxygen pump cell 2 with respect to the flow of the measurement target gas. In this embodiment, the electrode 3b of the sensor cell 3 is formed integrally with the electrode 2b of the first oxygen pump cell 2.

In this embodiment, in order to suppress decomposition of NOx in the measurement target gas, an electrode having low NOx decomposition activity is preferably used for the electrode 2a of the first oxygen pump cell 2 and the electrode 4a of the second oxygen pump cell 4. Specifically, a porous cermet electrode containing Pt (platinum) and Au (gold) as principal components is suitably used. In this case, the content of Au in the metal component is preferably about 0.5 to 5 mass %. In addition, in order to decompose NOx in the measurement target gas, an electrode having high NOx decomposition activity is preferably used for the electrode 3a of the sensor cell 3. Specifically, a porous cermet electrode containing Pt and Rh (rhodium) as principal components is suitably used. In this case, the content of Rh in the metal component is preferably about 10 to 50 mass % For example, a Pt porous cermet electrode is suitably used for the electrodes 2b, 4b, and 3b of the first oxygen pump cell 2, the second oxygen pump cell 4, and the sensor cell 3, respectively.

Further, as shown in FIG. 3, these electrodes 2a, 2b, 4a, 4b, 3a, and 3b are formed integrally with leads 2c, 2d (3d), 4c, 4d, 3c, and 3d, respectively, for taking electric signals from these electrodes. These leads are, like the respective electrodes, made of a cermet material containing, as principal components, a noble metal such as Pt and a ceramic such as zirconia. It is preferable that an insulating layer (not shown) such as alumina is formed between the solid electrolyte bodies 5, 6 and the leads 2c, etc., on the portions of the solid electrolyte bodies 5 and 6 other than the portions where the electrodes 2a, etc. are formed, particularly, on the portions where the leads 2c, etc. are formed.

The heater 12 is formed by patterning a heater electrode 14 that generates heat upon energization on an upper surface of an alumina heater sheet 13, and forming an alumina layer 15 for insulation on an upper surface (surface on the spacer 9 side) of the heater electrode 14. A cermet made of Pt and ceramics such as alumina is typically used for the heater electrode 14. The heater 12 generates heat when the heater electrode 14 is supplied with a current from outside to heat the respective cells 2, 3 and 4 up to their activation temperatures.

Further, as shown in FIG. 3, the respective cells 2, 3, and 4 and the heater electrode 14 are connected to the terminals P of the sensor base portion via through holes SH formed in the proximal end portions of the solid electrolyte bodies 5 and 6, the spacers 8, 9, and 91, the heater sheet 13, and the like.

As shown in FIG. 1, the lead wires H8 are connected through connectors to the terminals P by crimping, brazing, or a similar technique, thereby enabling exchange of signals between an external circuit and each of the respective cells 2, 3, and 4 and the heater 12.

The solid electrolyte bodies 5 and 6, the spacers 8, 9, and 91, the alumina layer 15, and the heater sheet 13 each can be molded into a sheet-like shape through a doctor blade method, an extrusion molding method, or a similar method.

The electrodes 2a, etc., the leads 2c, etc., and the terminals P each can be formed by screen printing or a similar technique. The respective sheets are stacked and baked to be integrated.

Next, the structure of the controller (control unit) C will be described. As shown in FIG. 2, the controller C is electrically connected to the gas sensor element 1 included in the NOx sensor S, and performs energization control for the NOx sensor S (gas sensor element 1). The term “energization control for the gas sensor” means a control to be executed when the controller C corresponding to the NOx sensor S is connected to the NOx sensor S.

The controller C includes a circuit C7 that electrically communicates with the first oxygen pump cell 2, a circuit C11 that electrically communicates with the second oxygen pump cell 4, a circuit C13 that electrically communicates with the sensor cell 3, and a microcomputer C1 that controls the entire circuit.

An ampere meter A1 and a power supply C5 are connected to the circuit C7, and the power supply C5 applies a predetermined voltage between the pair of electrodes 2a and 2b of the first oxygen pump cell 2. The microcomputer C1 detects a current value of the ampere meter A1. As shown in FIG. 5, when the power supply C5 applies a voltage V0, the current value of the ampere meter A1 indicates a limiting current I0.

An ampere meter A2 and a voltage-variable power supply C9 are connected to the circuit C11, and the power supply C9 applies a predetermined voltage between the pair of electrodes 4a and 4b of the second oxygen pump cell 4 under control of the microcomputer C1.

An ampere meter A3 and a power supply C17 are connected to the circuit C13, and the power supply C17 applies a constant voltage between the pair of electrodes 3a and 3b of the sensor cell 3. The microcomputer C1 detects a current value of the ampere meter A3.

Next, the operating principle of the gas sensor element 1 having the above structure will be described. In FIG. 2, the exhaust gas as a measurement target gas is introduced into the internal space 7 through the porous diffusion resistor 11. The amount of the gas introduced is determined depending on the diffusion resistance of the porous diffusion resistor 11.

When a voltage is applied between the pair of electrodes 2a and 2b of the first oxygen pump cell 2 and between the pair of electrodes 4a and 4b of the second oxygen pump cell 4 so that the electrodes 2b and 4b on the side of the first and second reference gas spaces 17 and 16 have positive polarity, oxygen in the measurement target gas is reduced to oxygen ions on the electrodes 2a and 4a on the internal space 7 side, and the oxygen ions are discharged to the side of the electrodes 2b and 4b by pumping action. In FIG. 2, the voltage is applied so that the electrodes 2b and 4b have positive polarity.

On the other hand, when a voltage is applied so that the electrodes 2a and 4a on the internal space 7 side have positive polarity, oxygen is reduced to oxygen ions on the electrodes 2b and 4b on the side of the first and second reference gas spaces 17 and 16, and the oxygen ions are discharged to the side of the electrodes 2a and 4a by the pumping action. In view of a relationship between an oxygen pump cell applied voltage V and an oxygen pump current I, which has been obtained in advance, a voltage is applied to the first oxygen pump cell 2 and the second oxygen pump cell 4 under energization control described later so that the oxygen pump current I shown in FIG. 5 is maintained at the limiting current I0, whereby the oxygen concentration in the internal space 7 can be controlled at a predetermined low concentration.

A predetermined voltage (e.g., 0.40 V) is applied between the pair of electrodes 3a and 3b of the sensor cell 3 so that the electrode 3b on the second reference gas space 16 side has positive polarity. Since the electrode 3a is a Pt—Rh cermet electrode that is active in decomposing NOx as a specific gas component, oxygen and NOx in the measurement target gas are reduced to oxygen ions on the electrode 3a on the internal space 7 side, and the oxygen ions are discharged to the electrode 3b side by pumping action. When NOx exists in the measurement target gas, the current value of the ampere meter A3 increases with increase in the NOx concentration, whereby the NOx concentration in the measurement target gas can be detected.

Next, the energization control by the controller C will be described.

In the present invention, a feedback control to change the voltage V applied to the second oxygen pump cell 4 while monitoring the oxygen pump current I of the first oxygen pump cell 2 is performed so that the oxygen pump current I when the constant voltage V0 is applied to the first oxygen pump cell 2 is maintained within a predetermined range of the limiting current (refer to FIG. 5).

The range in which the oxygen pump current I indicates the limiting current at the constant voltage V0 (in which the current is constant with respect to the voltage) is limited to a limiting current range of IL≦I≦IH shown in FIG. 5. If the oxygen pump current I is out of the limiting current range, it becomes difficult to accurately measure the oxygen concentration and accurately perform introduction or discharge of a predetermined amount of oxygen. If the voltage is increased, the limiting current range tends to shift toward the higher current side.

The constant voltage V0 and the limiting current range (IL≦I≦IH) correspond to “voltage set to a predetermined set value” and “a predetermined range (of an oxygen pump current)” respectively.

Specifically, at the beginning of the feedback control, the constant voltage V0 is applied to the first oxygen pump cell 2 and the second oxygen pump cell 4. When the oxygen gas concentration in the internal space 7 is high, the limiting current indicating the oxygen pump current I of the first oxygen pump cell 2 becomes IH that is higher than I0 as shown in FIG. 5. When the oxygen pump current of the first oxygen pump cell 2 exceeds IH, the oxygen concentration cannot be accurately measured as described above. Therefore, the voltage applied to the second oxygen pump cell 4 is increased from V0 to further pump out oxygen from the internal space 7 to the outside.

When the oxygen concentration in the internal space 7 is reduced due to the pumping-out of oxygen and thereby the limiting current indicating the oxygen pump current I of the first oxygen pump cell 2 becomes equal to or lower than IH, the voltage applied to the second oxygen pump cell 4 is fixed to the voltage at this time. At this time, since the oxygen concentration in the internal space 7 is the predetermined low concentration for measuring the NOx concentration, the NOx concentration is measured by the sensor cell 3. The oxygen concentration in the measurement target gas can also be obtained on the basis of the voltage applied to the second oxygen pump cell 4, the second oxygen pump current that flows through the second oxygen pump cell 4, the voltage applied to the first oxygen pump cell 2, and the oxygen pump current of the first oxygen pump cell 2. The latter is to obtain the oxygen concentration on the basis of the pump currents and applied voltages of the first oxygen pump cell 2 and the second oxygen pump cell 4 because the current (limiting current) measured when oxygen has been completely pumped out by the first oxygen pump cell 2 and the second oxygen pump cell 4 indicates the oxygen concentration in the internal space 7.

When the constant voltage V0 is applied to the first oxygen pump cell 2 and the second oxygen pump cell 4 at the beginning of the feedback control, if the limiting current indicating the oxygen pump current I of the first oxygen pump cell 2 is within the limiting current range of IL≦I≦IH as shown in FIG. 5, it is possible to accurately measure the oxygen concentration and pump out the predetermined amount of oxygen. Therefore, the voltage applied to the first oxygen pump cell 2 is controlled and oxygen is pumped out in a similar manner to that described above so that the oxygen concentration in the internal space 7 becomes the predetermined low concentration for measuring the NOx concentration. Then, in a similar manner to that described above, the oxygen concentration and the NOx concentration in the measurement target gas are obtained.

On the other hand, if the oxygen gas concentration in the internal space 7 is low even when the constant voltage V0 is applied to the first oxygen pump cell 2 and the second oxygen pump cell 4 at the beginning of the feedback control, the limiting current indicating the oxygen pump current I of the first oxygen pump cell 2 becomes lower than IL as shown in FIG. 5. When the oxygen pump current of the first oxygen pump cell 2 is lower than IL, the oxygen concentration cannot be accurately measured as described above. Therefore, the voltage applied to the second oxygen pump cell 4 is lowered from V0 to suppress pumping-out of oxygen from the internal space 7.

When the oxygen concentration in the internal space 7 is increased due to the pumping-out of oxygen being suppressed and thereby the limiting current indicating the oxygen pump current I of the first oxygen pump cell 2 becomes equal to or higher than IL, the voltage applied to the second oxygen pump cell 4 is fixed to the voltage at this time. Then, the NOx concentration is obtained in a similar manner to that described above. If the amount of oxygen in the internal space 7 is insufficient to increase the oxygen concentration even when pumping is stopped, the positive and negative polarities of the electrodes of the second oxygen pump cell 4 may be reversed to pump oxygen into the internal space 7 by using the second oxygen pump cell 4. If the current of the first oxygen pump cell is lower than the threshold value even when the second oxygen pump cell 4 is stopped, the positive and negative polarities of the electrodes of the second oxygen pump cell 4 may be reversed.

The gas sensor S according to the present embodiment performs a control to change the voltage V applied to the second oxygen pump cell 4 so that the oxygen pump current I when the voltage V0 is applied to the first oxygen pump cell 2 is maintained within the predetermined range (the limiting current range described above), and detects the NOx concentration while the oxygen concentration in the internal space 7 is kept constant by applying the predetermined voltage to the first oxygen pump cell 2.

Therefore, if the temperature of the first oxygen pump cell 2 is kept equal to or higher than a predetermined temperature that represents the relationship (current-voltage curve) between the oxygen pump cell applied voltage V and the oxygen pump current I as shown in FIG. 5, it is possible to accurately perform introduction or discharge of the predetermined amount of oxygen. As a result, the oxygen concentration in the internal space 7 can be promptly and accurately controlled by the first oxygen pump cell 2 and the second oxygen pump cell 4, and the NOx concentration can be accurately measured.

On the other hand, since the second oxygen pump cell 4 is used for the feedback control to maintain the oxygen pump current of the first oxygen pump cell 2 within the predetermined range with the applied voltage being changed, even when the temperatures of the first oxygen pump cell 2 and the second oxygen pump cell 4 are different from each other, the difference in temperature is less likely to affect the NOx concentration measuring accuracy.

Since the above-described limiting current range (IL≦I≦IH) varies depending on the applied voltage V0, the applied voltage V0 (limiting current range) may be determined in advance in accordance with an oxygen concentration range in measurement environment in which the gas sensor S is used, or an oxygen concentration range for which accurate control is required.

In the case where the sensor cell 3 and the first oxygen pump cell 2 are provided in a common solid electrolyte body, it is preferable that a voltage V1 applied to the first oxygen pump cell 2 and a voltage V2 applied to the second oxygen pump cell 4 satisfies a relationship of |V2|>|V1|. When this relationship is satisfied, the second oxygen pump current that flows through the second oxygen pump cell 4 becomes higher than the oxygen pump current that flows through the first oxygen pump cell 2. Therefore, the current of the first oxygen pump cell 2 that is provided in the same solid electrolyte body as the sensor cell 3 may be lower than that of the second oxygen pump cell 4, and the current that flows between the electrodes of the sensor cell 3 used for detection of NOx concentration is less likely to be affected, thereby realizing more accurate detection of NOx concentration. The initial values of the voltages applied to the oxygen pump cells 2 and 4 may be appropriately set so as to satisfy the relationship of |V2|>|V1| in accordance with the oxygen concentration range in the measurement environment in which the gas sensor S is used.

The microcomputer C1 detects the oxygen pump current I of the first oxygen pump cell 2 which is measured by the ampere meter A1, and performs a feedback control to change the voltage applied from the power supply C9 to the second oxygen pump cell 4 as described above, in accordance with a difference between the measured oxygen pump current I and the preset limiting current range (IL≦I≦IH) so that the oxygen pump current I is maintained within the limiting current range. Therefore, an arrow extending from the ampere meter A1 through the microcomputer C1 to the power supply C9 as shown in FIG. 2 corresponds to the feedback control.

The limiting current corresponds to a portion, in which the gradient is 0, of the current-voltage curve shown in FIG. 5.

Further, the NOx sensor S (gas sensor element 1) according to the present invention has the two oxygen pump cells (the first oxygen pump cell 2 and the second oxygen pump cell 4) facing the internal space 7, and controls the oxygen pump cells so as to keep the oxygen concentration in the internal space 7 constant. Therefore, the NOx sensor S is superior in oxygen pumping performance to a gas sensor having only one oxygen pump cell. In addition, since the first and second reference gas spaces 17 and 16 are in communication with atmospheric air, the oxygen ions can be promptly discharged by pumping action from the internal space 7 toward the first and second reference gas spaces 17 and 16, or in an opposite direction, independently of rich/lean atmosphere.

Thus, the oxygen concentration in the internal space 7 can be made uniform, and can be controlled to a predetermined low concentration. Therefore, the NOx concentration can be accurately detected with the simple structure in which the sensor cell 3 is disposed facing the internal space 7. In addition, since it is not necessary to dispose the sensor cell 3 in an internal space other than the internal space 7 and to provide communication between these inner spaces through another diffusion resistor, variations in the shapes of the inner spaces and the diffusion resistors caused by individual differences of the sensors can be reduced.

The present invention is not limited to the above embodiment, and it goes without saying that the invention includes various modifications and equivalents included in the spirit and scope of the invention.

For example, the gas sensor according to the present invention can be used not only as an NOx sensor mounted on an exhaust system of an internal combustion engine to control an injection amount of urea in a urea SCR system, but also as an NOx sensor for various types of NOx purifying systems to monitor NOx concentration downstream from an NOx storage and reduction catalyst, or to control recovery of the NOx storage and reduction catalyst, for example.

Further, the gas sensor according to the present invention can be used to detect, as a specific gas component, not only NOx but also SOx, oxygen, carbon dioxide, etc. In addition, the measurement target gas is not limited to the exhaust gas from the internal combustion engine. The gas sensor according to the present invention can be used for detection of specific gas components in various types of gases, thereby significantly improving the detection accuracy, and contributing to, for example, improvement of controllability of various systems.

In the above embodiment, the initial values of the voltages applied to the first oxygen pump cell 2 and the second oxygen pump cell 4 are the same voltage (V0). However, different voltages may be applied to the first oxygen pump cell and the second oxygen pump cell.

In the above embodiment, the first oxygen pump cell 2 and the sensor cell 3 are provided in the common solid electrolyte body 5, and the second oxygen pump cell 4 is provided in the other solid electrolyte body 6. Thus, the number of the solid electrolyte bodies is reduced to simplify the structure of the gas sensor S. In addition, since the first oxygen pump cell 2 to which a constant voltage is applied is provided in the solid electrolyte body 5 shared with the sensor cell 3, disturbance such as voltage fluctuation is suppressed to be applied to the sensor cell 3 through the solid electrolyte body 5, resulting in accurate measurement of NOx concentration.

### DESCRIPTION OF REFERENCE NUMERALS

C controller (control unit)
S NOx sensor (gas sensor)
1 gas sensor element
2 first oxygen pump cell
2a one electrode (of pair of electrodes)
2b the other electrode (of pair of electrodes)
3 sensor cell
3a one electrode (of pair of electrodes)
3b the other electrode (of pair of electrodes)
4 second oxygen pump cell
4a one electrode (of pair of electrodes)
4b the other electrode (of pair of electrodes)
5, 6 solid electrolyte body
7 internal space
11 porous diffusion resistor (diffusion resistor)
17 first reference gas space
16 second reference gas space
V0 constant voltage (voltage of predetermined set value)
I oxygen pump current of first oxygen pump cell
IL≦I≦IH predetermined range of oxygen pump current

1. A gas sensor unit comprising:
a gas sensor; and
a control unit, wherein
the gas sensor includes;
an internal space into which a target gas is introduced through a predetermined diffusion resistor, a first oxygen pump cell having a pair of electrodes which are disposed on a first solid electrolyte body having oxygen ion conductivity so that one of the electrodes faces the internal space, the first oxygen pump cell introducing oxygen into or discharging oxygen from the internal space by energization of the pair of electrodes, thereby to control an oxygen concentration in the internal space,
a second oxygen pump cell having a pair of electrodes which are disposed on a second solid electrolyte body having oxygen ion conductivity so that one of the electrodes faces the internal space, the second oxygen pump cell introducing oxygen into or discharging oxygen from the internal space by energization of the pair of electrodes, thereby to control the oxygen concentration in the internal space, and
a sensor cell having a pair of electrodes which are disposed on a third solid electrolyte body having oxygen ion conductivity so that one of the electrodes faces the internal space, the sensor cell detecting a concentration of a specific gas component in the target gas on the basis of a value of a current that flows in the pair of electrodes;
the control unit is electrically connected to the gas sensor and sets a voltage between the pair of electrodes of the first oxygen pump cell to a predetermined set value; and
the control unit performs energization control that controls the introduction or discharge of oxygen while changing a voltage applied between the pair of electrodes of the second oxygen pump cell so that an oxygen pump current between the pair of electrodes of the first oxygen pump cell is maintained within a predetermined range.

2. The gas sensor unit according to claim 1, wherein
the first and third solid electrolyte bodies are a common solid electrolyte body,
the first oxygen pump cell and the sensor cell are provided in the common solid electrolyte body, and
the second solid electrolyte body is another solid electrolyte body.

3. The gas sensor unit according to claim 1, wherein the set value is one constant value.

4. The gas sensor unit according to claim 2, wherein the set value is one constant value.
